(19) United States
(12) Patent Application Publication
(10) Pub. No.: US 2015/0239404 A1
(43) Pub. Date: Aug. 27, 2015

(54) MOUNT FOR MOBILE

(71) Applicant: DONG YEOB LEE, GYEONGGI-DO (KR)

(72) Inventor: DONG YEOB LEE, GYEONGGI-DO (KR)

(73) Assignee: SHINHYEONG INT CO., LTD., GYEONGGI-DO (KR)

(21) Appl. No.: 14/632,733

(22) Filed: Feb. 26, 2015

(30) Foreign Application Priority Data
Feb. 27, 2014 (KR) 20-2014-0001528

(51) Int. Cl. B60R 11/02

(52) U.S. Cl. CPC B60R 11/02; B60R 2011/0087

(57) ABSTRACT

Disclosed herein is a claw-type mount for a mobile device. The present invention relates to a claw-type mount for a mobile device in which the clamping force of a grab having first and second claws is maintained by a plate spring type elastic member of alphabet letter “C” shape provided around a swing shaft located in the rear of a holding part for the mobile device; and this elastic member is easily attachable to and detachable from the respective installation parts of first and second claws, thereby having an excellent assemblability and maintenance convenience.

### CROSS-REFERENCE TO RELATED APPLICATION

This application claims priority to Korean Utility Model Application No. 20-2014-0001528, filed on Feb. 27, 2014, the disclosure of which is incorporated herein by reference in its entirety.

### BACKGROUND OF THE INVENTION

1. Field of the Invention

Exemplary embodiments of the present invention relate to a mount for a mobile device, and more particularly, to a claw-type mount for a mobile device in which clamping force of a grab having first and second claws is maintained by a plate spring type elastic member of an alphabet letter “C” shape provided around a swing shaft located in the rear of a holding part for the mobile device; and this elastic member is easily attachable to and detachable from the respective installation parts of first and second claws, as the result having excellent assemblability and maintenance convenience; being applicable to various designs, sizes and kinds of mobile devices; and allowing safety and serviceability to be maximized at the time of mounting mobile devices on the vehicle.

2. Description of the Related Art

Recently people have been using various mobile devices such as smartphones, tablet-PCs and navigations, regardless of time and place. In addition, such various mobile devices are utilized in various fields such as business, pastime, information acquisition, education and geographical guide.

For the sake of the convenience of a user at the time when the user places various mobile devices on the desks or the tables, is moving or fastens them to the vehicle, a variety of holders or mounts were developed in the past.

In the prior art, a smartphone navigation holder is disclosed in Korean Patent Laid-Open Publication No. 10-2013-0080201 (published on Jul. 12, 2013) in which the holder is engaged between a circular rim and a hub of a steering wheel, and a user is capable of safely viewing a navigation screen during driving by mounting a smartphone on the vehicle wherein a navigation application for a vehicle which responds to the rotation direction of the steering wheel is installed in the smartphone.

However, the above patent publication differs from the prior art in that the mobile device is mounted on the steering wheel of the vehicle but does not show any technical difference from various conventional holders (mounts) in terms of the holder (mount) itself for the mobile device such as the smartphone.

That is, the holder (mount) of the above patent publication is substantially the same as a holster of a folder type portable terminal of Korean Utility Model Registration No. 20-0163819 (registered on Oct. 4, 1999) but is more distant than technologies of commonly mounting various sizes of mobile devices.

Meanwhile, the applicant of the present invention disclosed a portable device holder mounted on CD slot with a simple attachment and detachment structure, of Korean Patent No. 10-1219760 (registered on Jan. 2, 2013) and a portable device holder for vehicle capable of being easily mounted, of Korean Patent No. 10-1279160 (registered on Jun. 20, 2013).

In the above patents of the applicant of the present invention a supporting part serves as fixing the holder to the CD slot of the vehicle and a holding part is provided with a variable plate available to an opening operation.

However, these two patents have disadvantages in which the component number of the holder is great and also have the limit in commonly mounting various thicknesses and sizes of mobile devices or even mobile devices having various colors and materials of protective covers. In addition, these two patents have the problem regarding the limited diversification of design.

Further, Korean Patent Laid-Open Publication No. 10-2012-0121575 (published on Nov. 6, 2012) discloses a portable terminal holder which enables a user to use the portable terminal regardless of the size of the portable terminal in the environment in which a user is situated and in a fixed installation state of the portable terminal, and at the same time the installation direction of the portable terminal of the fixed installation state may be changed.

However, the claw-type holder of the above patent application publication has the problem which, so as to mount the mobile device, one hand of a driver has to maintain the state in which the claws is spread and the other hand thereof has to hold and mount the mobile device. As the result, when the situation happens that a driver has to mount the mobile device during driving, with the holder described in the above patent application publication, the mounting itself may be impossible. In addition, in case the driver tries to mount the mobile device by force, the danger of causing an accident may occur.

### SUMMARY OF THE INVENTION

One object of the present invention is to provide a claw-type mount for a mobile device having improved assemblabilty and maintenance convenience wherein clamping force of a grab having first and second claws is maintained by a plate spring type elastic member of an alphabet letter “C” shape provided around a swing shaft located in the rear of a holding part for the mobile device; and this elastic member is easily attachable to and detachable from the respective installation parts of first and second claws.

Another object of the present invention is to provide a claw-type mount for a mobile device wherein the claw-type mount enables flexible market management for the release state of various sizes and kinds of mobile devices from the outdated model to the latest model and may be applied in various design applications.

A further object of the present invention is to provide a claw-type universal mount for a mobile device capable of maximizing safety and convenience at the time of mounting the mobile device because a user may hold the mobile device only by one hand and dispose the mobile device on the holding part while spreading the first and second claws, as the claw-type universal mount comprises an open inserting portion configured by the first and second claws being always spaced apart.

In accordance with one aspect of the present invention for achieving the objects of the present invention, a claw-type mount for a mobile device may include a base; a link body connected to the base; a swing shaft; first and second claws including first and second coupling parts for the swing shaft, first and second holding parts for the mobile device configured to be always spaced apart to form an open inserting portion, and first and second installation parts, respectively; and a claw-type grab which includes an elastic member coupled to the first and second installation parts to maintain a retraction state of the first and second claws and which are coupled to the link body.

In addition, in one embodiment of a claw-type mount for a mobile device in accordance with the present invention, the first coupling part of the first claw is coupled to a shaft pin which the swing shaft comprises; the second coupling part of the second claw comprises a shaft insert portion having an opening into which the shaft pin is inserted.

In addition, in one embodiment of a claw-type mount for a mobile device in accordance with the present invention, the elastic member is a plate spring whose cross-sectional shape is alphabet letter ‘C’ shape.

In addition, in one embodiment of a claw-type mount for a mobile device in accordance with the present invention, the first installation part of the first claw and the second installation part of the second claw each include a coupling groove so as to prevent detachment of the end of the plate spring.

In addition, in one embodiment of a claw-type mount for a mobile device in accordance with the present invention, the first coupling part of the first claw includes a first guide member safely guiding a swing motion of the first claw, and the second coupling part of the second claw includes a second guide member safely guiding a swing motion of the second claw.

In addition, in one embodiment of a claw-type mount for a mobile device in accordance with the present invention, the link body further includes: a first angle adjusting means installed on the bottom end of the link body and for adjusting up and down angle of the mobile device; and a second angle adjusting means installed on the top end of the link body and for adjusting a rotational angle of the mobile device.

In addition, in one embodiment of a claw-type mount for a mobile device in accordance with the present invention, the base is inserted into and engaged with a ventilator grill of a vehicle and is of a ring shape.

In accordance with another aspect of the present invention for achieving the objects of the present invention, a claw-type mount for a mobile device may include: a swing shaft; a first claw including a first coupling part for the swing shaft, a first holding part for the mobile device, and a first installation part; a second claw including a second coupling part for the swing shaft, a second holding part for the mobile device, and a second installation part; and a claw-type grab including an elastic member coupled to the first installation part and the second installation part so as to maintain a retraction state of the first and second claws.

In addition, in one embodiment of a claw-type mount for a mobile device in accordance with the present invention, the first holding part and the second holding part are configured to be always spaced apart to form an open inserting portion.

In addition, in one embodiment of a claw-type mount for a mobile device in accordance with the present invention, the first coupling part of the first claw may include a shaft pin which the swing shaft may comprise; and the second coupling part of the second claw may include a shaft insert portion.

In addition, in one embodiment of a claw-type mount for a mobile device in accordance with the present invention, the shaft insert portion may further comprise an opening which the shaft pin is inserted into and coupled to.

In addition, in one embodiment of a claw-type mount for a mobile device in accordance with the present invention, the elastic member may be a plate spring whose cross-sectional shape is an alphabet letter ‘C’ shape.

In addition, in one embodiment of a claw-type mount for a mobile device in accordance with the present invention, the first installation part of the first claw and the second installation part of the second claw each may include a coupling groove so as to prevent detachment of the end of the plate spring.

In addition, in one embodiment of a claw-type mount for a mobile device in accordance with the present invention, the coupling groove may further comprise a detachment stopper so as to prevent detachment of the plate spring.

In addition, in one embodiment of a claw-type mount for a mobile device in accordance with the present invention, the first holding part and the second holding part each may include an elastic damping member formed on a region where the mobile device is in contact coupling.

In addition, in one embodiment of a claw-type mount for a mobile device in accordance with the present invention, the first coupling part of the first claw may include a first guide member safely guiding a swing motion of the first claw, and the second coupling part of the second claw may include a second guide member safely guiding a swing motion of the second claw.

In addition, in one embodiment of a claw-type mount for a mobile device in accordance with the present invention, the first coupling part and the first holding part, and the first installation part of the first claw may be integrally formed and the second coupling part and the second holding part, and the second installation part of the second claw may be integrally formed.

In addition, in one embodiment of a claw-type mount for a mobile device in accordance with the present invention, the first coupling part, the shaft pin, the first holding part and the first installation part of the first claw may be integrally formed; and the second coupling part, the shaft insert portion, the second holding part and the second installation part of the second claw may be integrally formed.

The prevent invention has the advantages of being capable of increasing assemblability and maintenance convenience because the clamping force of a grab having first and second claws is maintained by a plate spring type elastic member of an alphabet letter “C” shape provided around a swing shaft located in the rear of a holding part for the mobile device; and this elastic member is easily attachable to and detachable from the respective installation parts of first and second claws.

In addition, the present invention has the benefit in that the claw-type mount enables flexible market management for the release state of various sizes and kinds of mobile devices from the outdated model to the latest model and may be applied in various design applications.

Further, the present invention has the advantage of capable of maximizing safety and convenience at the time of mounting the mobile device on the vehicle because the first and second claws are configured to be always spaced apart to form an open inserting portion, thus a user may hold the mobile device only by one hand and dispose the mobile device on the holding part while spreading the first and second claws.

Also, the present invention has the advantage of greatly increasing an assemblability and maintenance convenience because a shaft pin is provided for a first coupling part of the first claw among the first and second claws, in particular a shaft pin integrally formed is provided; and a shaft insert portion to which the shaft pin is coupled is provided for a second coupling part of the second claw in the way of including an opening.

Further, the present invention has the advantage of being capable of improving both assemblability and safety of spread and retraction operations of first and second claws in the assembled state because a coupling groove for preventing detachment of the end of a plate spring is formed on the respective first and second installation parts of the first and second claws.

Also, the present invention has various advantages in that as the first and second coupling parts of the first and second claws each have a guide member guiding safely a swing motion of the claw, repetitive spread and retraction operations may be also be performed safely without failure or error and thus durability may be enhanced; even at the time of mounting various sizes of mobile device, the easy and safe spread of the claws is possible; the elastic member configured as a plate spring like alphabet letter ‘C’ is covered by the circular second guide member and thus detachability of the elastic member due to external shock is originally blocked off; as the result, a new design of esthetic sense based on simple beauty may be provided. Therefore the invention has the advantages of going beyond the needs of the customers and setting the trend because the mount for mobile device in accordance with the present invention may keep step with the current trend where mobile devices, in particular a smartphone and protective cases thereof become one of fashion items like clothes and watches.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a combination view of a claw-type mount for mobile device in accordance with the present invention.

FIG. 2 is a side view of the claw-type mount for mobile device in accordance with the present invention.

FIG. 3 is an exploded perspective view of the claw-type mount for mobile device in accordance with the present invention.

### DESCRIPTION OF SPECIFIC EMBODIMENTS

Hereinafter, some exemplary embodiments of the present invention are described in detail with reference to the accompanying drawings.

It should be understood, however, that the following description, while indicating specific embodiments of the present invention and numerous specific details thereof, is given by way of illustration and not of limitation. Many substitutions, modifications, additions and/or rearrangements may be made within the scope of the present invention without departing from the spirit thereof, and the present invention includes all such substitutions, modifications, additions and/or rearrangements.

In each drawing, the same reference numeral, in particular the same number including 10-digit and 1-digit, or the same reference numeral including 10-digit, 1-digit and alphabet indicates an element having the same or like function. Unless particularly indicated, the element which each reference numeral indicates is understood as an element on the basis of such standard.

In addition, elements in each drawing, are expressed as being exaggeratedly great or thick or small or thin in size or thickness or simplified for the sake of ease and clarity of understanding, but the scope of the present invention should be construed as not being limited thereto.

The terms used below, are used to describe simply specific embodiments and are not intended to limit the scope of the invention. A singular term preceded by “a” or “an” (and “the” when antecedent basis is “a” or “an”) includes the plural of such term, unless clearly indicated otherwise. As used herein, the terms “comprises,” “comprising,” “includes,” “including,” “has,” “having,” or any other variation thereof, are intended to cover a non-exclusive inclusion. For example, a feature, number, process, product, article, apparatus or the combination thereof that comprises a list of elements is not necessarily limited only those elements but may include other elements not expressly listed or inherent to such feature, number, process, product, article, apparatus or the combination thereof.

Unless defined otherwise, all terms used herein including technical or scientific terms have the same meanings as those generally understood by a person skilled in the art. The terms such as those defined in the dictionaries generally used should be construed as the meanings which are consistent with those understood in the context of the relevant technologies. These terms should not, unless clearly defined in the specification, be construed as ideally or excessively formal meanings.

The terms such as “(a/the) first” and “(a/the) second” used in the specification are intended to simply indicate different elements and are free of the fabricated order. These terms may be inconsistent in terms of the name in the detailed description and claims.

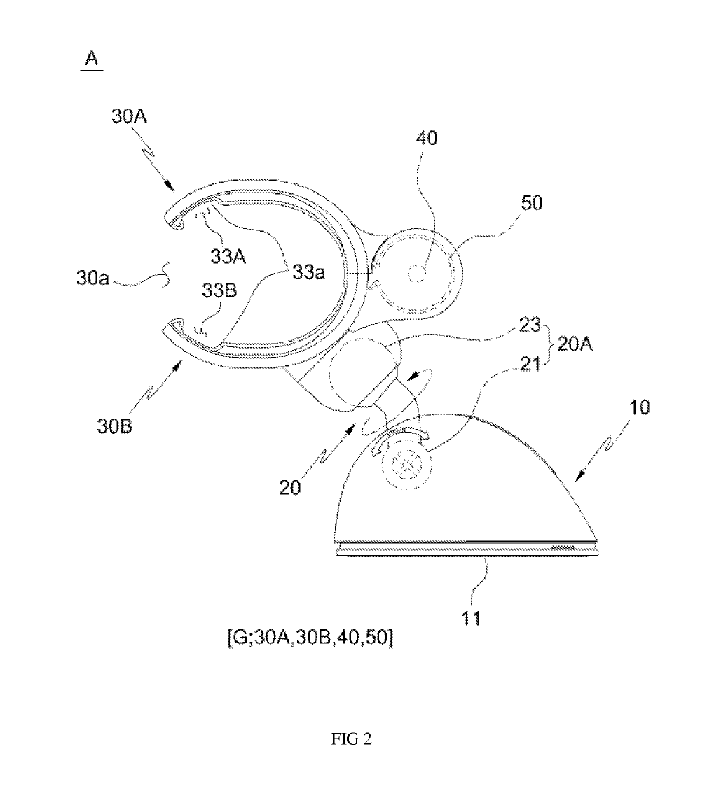

While describing a claw-type universal mount (A) for mobile device according to the present invention, for the sake of convenience, loose and approximate direction reference is specified with reference with FIG. 2 and thus the upper and lower sides, the left and right sides, and the front and rear sides are divided. The detailed description related with other drawings and claims will also be direction-specified and described according to this reference.

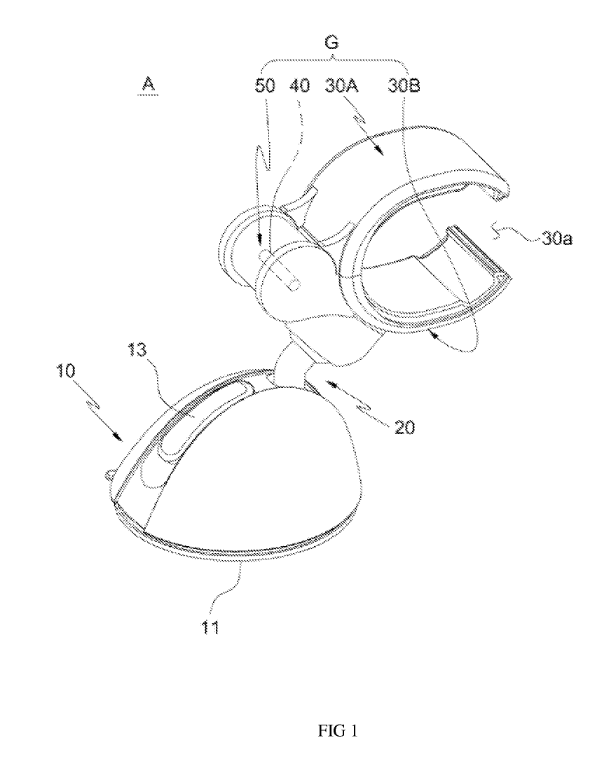

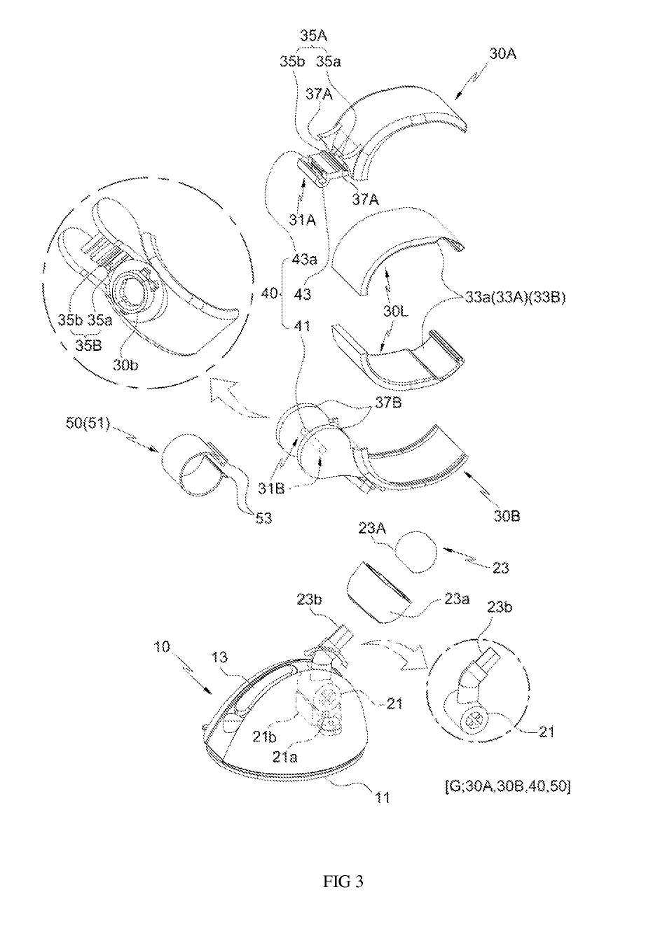

First, as identified by a perspective view of FIG. 1, a side view of FIG. 2, and an exploded perspective view of FIG. 3, a claw-type universal mount (A) for a mobile device according to the present invention includes generally a base 10 attached on a dash board of a vehicle or a table; a grab G including first and second claws 30A and 30B; and a link body 20 connecting the base 10 and the grab G.

The base 10 comprises a sucking disc 11 on the bottom surface thereof and has the structure in which if a lever 13 provided for a base body is pushed as shown in FIG. 1, the sucking disc 11 is pulled upwardly due to an actuation of a cam provided for the lever 13, thereby being capable of further strengthening a suction state.

The base 10 may be alternatively replaced by various shapes of bases such as a vehicle CD slot type base (see Korean Patent No. 10-1219760 registered on Jan. 2, 2013 entitled a mobile device mount for CD slot attachment having a simple detachable structure and Korean Patent No. 10-1279160 registered on Jun. 20, 2013 entitled a mobile device mount for a vehicle capable of being easily attached) and an attachment-type base using a double-sided adhesive tape.

The link body 20 has a bar-type structure in which an upper neck portion thereof is bent to the left side but is not necessarily limited thereto. If necessary, the link body 20 may be composed of a corrugated tube of various lengths (that is, a flexible tube) or an articulated body (e.g., the connected structure of a plurality of universal joints, etc. employed in a rotational displacement angle adjusting means 23 using a ball).

In addition, as illustrated in FIGS. 2 and 3, the link body 20 includes a displacement means or an angle adjusting means 20A, thereby being capable of changing an angle, a height and a rotation for a change of viewpoint of a mobile device displaced on holding parts 33A and 33B of claws 30A and 30B of the grab G.

The first angle adjusting means 21 which is coupled to the base 10 and provided at an lower end of the link body 20 (see a circle indicated in one-dotted circle on the bottom right side of FIG. 3) may be moved up and down, thereby being capable of adjusting an angle of a held mobile device. As the result, as the height of the mobile device is also adjusted, the first angle adjusting means 21 also plays the role of a kind of height displacement means. The angle adjusting means 21 is not necessarily limited thereto and the height displacement means may be employed in various ways, if necessary.

As illustrated in FIG. 3, after the up and down movement of the first angle adjusting means 21 is completed, even in the state where various weights of mobile devices are mounted, in order that the movement of the first angle adjusting means 21 may be maintained as the state of being adjusted, at the bottom surface of a drum-type angle adjusting means 21 is provided a bar-type friction member 21a which is arranged to always be in contact with the first angle adjusting means 21 by a bolt engagement lower bracket 21b which serves as fixing the angle adjusting means 21 to the base 10. The up and down angle adjustment of the first angle adjusting means 21 is made a little tightly by a friction member 21a such as a rubber material.

In addition, the link body 20 includes a second angle adjusting means 23 comprising a ball-type rotating body coupled in the interference fit (or be bonded by an adhesive) to a hexagonal part 23b at the upper end of the link body 20. First, the ball-type rotating body 23A is arranged in a dish-type receptor 23a. Next, the receptor 23a is coupled to a lower engaging portion 30b of the second claw 30B (see a bottom perspective view of the second claw illustrated in the one-dotted circle on the top left side of FIG. 3). After that, the link body 20 is completed by inserting the hexagonal part 23b at the upper end of the link body 20 into a coupling groove of the ball-type rotating body 23A. That is, a first semi assembly including the base 10, the link body 20 and the second claw 30B is formed.

The second angle adjusting means 23 corresponds to a kind of a rotational displacement means for a mobile device. In addition, the second angle adjusting means 23 is composed of a universal joint available up to a minute up and down adjustment, thereby finally being capable of performing a rotational angle adjustment and an omnidirectional angle adjustment.

Furthermore, it is preferable that a coating such as a rubber coating or a member for preventing arbitrary change of displacement such as a friction member and a slip prevention member similar to the first angle adjusting means is applied to the ball-type rotating body 23A and the dish-type receptor 23a of the second angle adjusting means 23.

Next, a grab G of the claw-type mount A for mobile device in accordance with the invention will be described.

The grab G having first and second claws 30A and 30B being capable of being separated from each other further comprises a swing shaft 40 and an elastic member 50. The first and second claws 30A and 30B are provided with first and second holding parts 33A and 33B for mobile device which are configured to be always spaced apart to form an open inserting portion 30a.

As the first and second holding parts for the mobile device configured to be always spaced apart to form such an open inserting portion are provided, it is possible for a user to hold the mobile device only by one hand while spreading the claws and then disposing the mobile device on the holding parts. As the result, safety and convenience may be maximized at the time mounting the mobile device on the vehicle.

In addition, the mount according to the invention provides particularly a great benefit in case that a user has to mount the mobile device unavoidably in various states or reasons during driving, in light of the real condition that the holder or mount for mobile device is installed and used on the vehicle.

More particularly, as illustrated in FIG. 3, the first and second claws 30A and 30B comprising the swing shaft 40 are coupled to each other through the swing shaft 40 at the first and second coupling parts 31A and 31B of the first and second claws 30A and 30B. The grab G may be mounted on a dash board of a vehicle using a sucking disc 11 of the base 10, wherein the grab G is configured to form an open inserting portion 30a always spaced apart by the elastic member 50 coupled to the first and second installation parts 35A and 35B, in particular, by a plate spring 51 whose cross-sectional shape is similar to an alphabet letter ‘C’ shape. That is, if a user applies a force upwardly with the top side surface of the mobile device being coupled to the holding part 33A of the first claw 30A, the gap of the plate spring 51 is getting wider; the end on the left side of the first claw 30A is spaced apart further from the end on the left side of the second claw 30B by taking the swing shaft 40 as an axis; and the open inserting portion 30a is also further spaced. After that, at any time when the open inserting portion 30a gets wider than the width of the mobile device, if a user pushes the bottom side surface of the mobile device to the right in such a manner that the bottom side surface of the mobile device may disposed on the holding part 33B of the second claw 30B and then removes the applying force, the first claw 30A is again lowered centering on the swing shaft due to elasticity of the plate spring and the mobile device is clamped between the first and second holding parts 33A and 33B. Thus, the mounting is achieved.

On the other hand, the first and second claws 30A and 30B includes first and second coupling parts 31A and 31B for the swing shaft 40; first and second holding parts 33A and 33B for mobile device configured to be always spaced apart to form an open inserting portion 30a; and first and second installation parts 35A and 35B. In addition, these all elements are integrally formed into one body.

In addition, the holding parts 33A and 33B each are provided with an elastic damping part 33a wherein the mobile device is directly mounted on the holding parts 33A and 33B. This elastic damping part functions as preventing an installed mobile device from being arbitrarily detached due to the characteristic friction force of its material as well as protecting the mobile device from the shock or the vibration.

The elastic damping part is formed of a variety of elastomer materials such as expanded synthetic resin (e.g., expanded polyurethane), synthetic rubber and silicone and if necessary, may also be configured to be integrally formed all over the first and second claws. However, an elastic liner 30L is employed in FIGS. 2 and 3 wherein the elastic liner 30L is applied in the way of a double injection or an insert injection, an adhesive attachment method, etc., all over the insides of the claws including the holding parts.

Another core feature of the universal mount (A) for the mobile device in accordance with the invention is that even the shaft pin 41 and the shaft insert portion 43 forming the swing shaft 40 are integrally formed with the corresponding claw of the first and second claws 30A and 30B, as well as the coupling part 31A and 31B, the holding part 33A and 33B and the installation parts 35A and 35B of the first and second claws 30A and 30B, respectively being integrally formed.

In this way, as even the shaft pin and the shaft insert portion forming the swing shaft are integrally formed with the respective first and second claws, assemblability is greatly improved and even easiness of disassembling for assembly and maintenance of an elastic member 50 to be described later may be achieved.

As shown in FIG. 3, the first coupling part 31A of the first claw 30A is coupled to the shaft pin 41 which constitutes the swing shaft 40, in particular is integrally formed with the shaft pin 41 (wherein an injection molding or an insert molding can also be used), and at the second coupling part 31B of the second claw 30B is formed the shaft insert portion 43 into which the shaft pin 41 is inserted.

In addition, the shaft insert portion 43 includes an opening 43a whose one side (in particular top side) is opened. As the result, at the time of assembling the first semi assembly including the base 10, the link body 20 and the second claw 30B, the following steps are performed: erecting the claw 30A in a vertical position; inserting the projected first coupling part 31A of a flat plate type between two spaced discs of the second coupling part 31B which the second claw 30B comprises; then coupling the shaft insert portion 43 to the shaft pin 41 through the opening 43a; finally rotating the shaft insert portion 43, around the shaft pin 41 such that the first claw 30A is in a horizontal state and finally coupling two claws.

Disassembling is performed in the reverse order to assembling.

At the time of assembling, the rim of two-spaced-disc type coupling part 31B of the second claw 30B serves as a second guide member 37B; and a first guide member 37A on the right side of the first claw which projects in the interspaced shape (each being a triangle-like shape) is in a face contact with the second guide member 37B, thereby be capable of maintaining the safe coupling state of two claws, even if temporarily.

The bottom surface of the first guide member 37A has an arc shape corresponding to the shape of the rim of the circular second guide member 37B of the disc type coupling part 31B.

The first and second guide members having these shapes are coupled to the second and first claws respectively but the reverse arrangement position thereof is available.

Due to the first and second guide member 37A and 37B, the first and second claws enable a safe swing motion for a clamping operation of the mobile device. Thus repetitive spread and retracted operation of the claws may also be performed without failure or error and durability may be enhanced.

Next, the mount A is completed by coupling the second semi assembly including the base 10, the link body 20, the first claw 30A, the second claw 30B and the swing shaft 40 to the elastic member 50. In particular, this elastic member 50 is composed of the plate spring 51 whose cross-sectional shape is like the shape of the alphabet letter ‘C’. Further, both ends of the plate spring each are bent upwardly, thus forming a bent end 53. Therefore assemblability and safety are enhanced.

The respective first and second installation parts 35A and 35B of the first and second claws 30A and 30B for coupling of the plate spring 51 are arranged around the first and second coupling part 31A and 31B. In particular, the first installation part and the second installation part each include the coupling groove 35a for preventing detachment of the end of the plate spring 51. The coupling groove 35a further comprises a detachment stopper 35b formed by deepening further the depth of the coupling groove, to enable the bent end 53 of the plate spring 51 to be smoothly coupled and to prevent detachment of the plate spring.

The coupling groove 35a and the detachment stopper 35b which constitute the first installation part 35A of the first claw 30A may be identified in the FIG. 3. The coupling groove 35a and the detachment stopper 35b which constitute the second installation part 35B of the second claw 30B may be identified in a bottom perspective view of the second claw shown within the one-dotted circle on the top left side of FIG. 3.

At the time the plate spring is coupled to the second semi assembly, it is possible to widen a little the gap between the bent ends 53 of the plate spring by using bare hands or various tools; and push the up and down bent ends 53 as they are, with the bent ends 53 being hung on the respective detachment stoppers 35b of the first and second installation parts 35A and 35B located on the left side of the shaft pin 41, thereby allowing the bent ends 53 to be easily coupled to the respective coupling grooves 35a. That is, a finished body including the base 10, a link body 20, the first and second claws 30A and 30B, the swing shaft 40 and the elastic member 50, i.e., the universal mount A of the mobile device is obtained.

Meanwhile, as shown in FIG. 2, the plate spring 51 of the elastic member 50 is covered by the circular second guide member 37B (or the second coupling part 31B) and thus detachability of the elastic member due to an external impact is originally blocked off. As the result, a simple design is provided; even in the situation of mounting various sizes of mobile devices, easy and safe spreading and retracting operations of the claws are assured; and it is possible to maintain safe mounting state of the mobile device.

In the above description, a generally known technology related with the elastic damping portion, the angle adjusting means, the elastic member and the claws and the specific assembling process thereof and the mounting process of the mobile device, etc., is omitted but a person skilled in the art would easily speculate, infer and reproduce this.

In addition, in describing the present invention above, the mount having the specific shapes and structures are described mainly with reference to the accompanying drawings but it would be apparent to those skilled in the art that various changes, modifications and substitutions may be made without departing from the spirit and scope of the invention as defined in the following claims.

What is claimed is:

1. A claw-type mount for a mobile device comprising:
a base;
a link body connected to the base;
a swing shaft;
first and second claws including first and second coupling parts for the swing shaft, first and second holding parts for the mobile device configured to be spaced apart to form an open inserting portion, and first and second installation parts, respectively; and
a claw-type grab which includes an elastic member coupled to the first and second installation parts to maintain a retraction state of the first and second claws and which is coupled to the link body.

2. The claw-type mount for a mobile device according to claim 1, wherein the first coupling part of the first claw is coupled to a shaft pin which the swing shaft comprises; and the second coupling part of the second claw comprises a shaft insert portion having an opening into which the shaft pin is inserted.

3. The claw-type mount for a mobile device according to claim 2, wherein the elastic member is a plate spring whose cross-sectional shape is alphabet letter ‘C’ shape.

4. The claw-type mount for a mobile device according to claim 3, wherein the first installation part of the first claw and the second installation part of the second claw each include a coupling groove so as to prevent detachment of the end of the plate spring.

5. The claw-type mount for a mobile device according to claim 4, wherein:
the first coupling part of the first claw includes a first guide member safely guiding a swing motion of the first claw, and
the second coupling part of the second claw includes a second guide member safely guiding a swing motion of the second claw.

6. The claw-type mount for a mobile device according to claim 5, wherein the link body further includes:
a first angle adjusting means installed on the bottom end of the link body and for adjusting up and down angle of the mobile device; and
a second angle adjusting means installed on the top end of the link body and for adjusting a rotational angle of the mobile device.

7. The claw-type mount for a mobile device according to claim 6, wherein the base is inserted into and engaged with a ventilator grill of a vehicle and is of a ring shape.

8. A claw-type mount for a mobile device comprising:
a swing shaft;
a first claw including a first coupling part for the swing shaft, a first holding part for the mobile device, and a first installation part;
a second claw including a second coupling part for the swing shaft, a second holding part for the mobile device, and a second installation part; and
a claw-type grab including an elastic member coupled to the first installation part and the second installation part so as to maintain a retraction state of the first and second claws.

9. The claw-type mount for a mobile device according to claim 8, wherein the first holding part and the second holding part are configured to be spaced apart to form an open inserting portion.

10. The claw-type mount for a mobile device according to claim 9, wherein the first coupling part of the first claw includes a shaft pin which the swing shaft comprises; and the second coupling part of the second claw includes a shaft insert portion.

11. The claw-type mount for a mobile device according to claim 10, wherein the shaft insert portion further comprises an opening which the shaft pin is inserted into and coupled to.

12. The claw-type mount for a mobile device according to claim 11, wherein the elastic member is a plate spring whose cross-sectional shape is alphabet letter ‘C’ shape.

13. The claw-type mount for a mobile device according to claim 12, wherein the first installation part of the first claw and the second installation part of the second claw each include a coupling groove so as to prevent detachment of the end of the plate spring.

14. The claw-type mount for a mobile device according to claim 13, wherein the coupling groove further comprises a detachment stopper so as to prevent detachment of the plate spring.

15. The claw-type mount for a mobile device according to claim 14, wherein the first holding part and the second holding part each include an elastic damping member formed on a region where the mobile device is in contact coupling.

16. The claw-type mount for a mobile device according to claim 15, wherein
the first coupling part of the first claw includes a first guide member safely guiding a swing motion of the first claw, and
the second coupling part of the second claw includes a second guide member safely guiding a swing motion of the second claw.

17. The claw-type mount for a mobile device according to claim 16, wherein
the first coupling part and the first holding part, and the first installation part of the first claw are integrally formed and
the second coupling part and the second holding part, and the second installation part of the second claw are integrally formed.

18. The claw-type mount for a mobile device according to claim 17, wherein
the first coupling part, the shaft pin, the first holding part and the first installation part of the first claw are integrally formed; and
the second coupling part, the shaft insert portion, the second holding part and the second installation part of the second claw are integrally formed.
